(19) United States
(12) Patent Application Publication
(10) Pub. No.: US 2010/0238145 A1
(43) Pub. Date: Sep. 23, 2010

(54) ELECTRO-OPTICAL APPARATUS AND DRIVING METHOD THEREOF, AND ELECTRONIC DEVICE

(75) Inventors: Kota MUTO, Suwa (JP); Yuko KOMATSU, Suwa (JP); Kazunori HIRAMATSU, Okaya (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/717,319

(22) Filed: Mar. 4, 2010

(30) Foreign Application Priority Data
Mar. 19, 2009 (JP) 2009-068735
Aug. 14, 2009 (JP) 2009-187967

(51) Int. Cl. G09G 5/00

(52) U.S. Cl. 345/204

(57) ABSTRACT

An electro-optical apparatus includes a display unit including a plurality of pixels, a plurality of pixel electrodes, each of the plurality of pixel electrodes being provided for the pixel, a common electrode facing the plurality of pixel electrodes, an electro-optical layer disposed between the plurality of pixel electrodes and the common electrode, a plurality of holding capacitors, each of the plurality of holding capacitors being provided for the pixel, a capacitance line connected to the electrode of the holding capacitor, and a control unit that controls the potentials of the plurality of pixel electrodes, the common electrode, and the capacitance line. The control unit executes, during an image display period in which an image is displayed in a display unit in which the pixels are arranged, a capacitance line potential change operation that changes the potential of the capacitance line in tandem with the potential of the common electrode so that the potential difference between the potential of the capacitance line and the potential of the common electrode decreases.

### BACKGROUND

1. Technical Field

The present invention relates to an electro-optical apparatus, a driving method thereof, and an electronic device.

2. Related Art

In the field of electrophoretic display apparatuses, a driving method whereby the potential of a common electrode is changed in order to prevent increasing the driving voltage beyond a necessary level (common-inversion driving) is known (see, for example, JP-A-2002-149115). In addition, 1T1C pixel circuits, in which a switching element and a capacitor are provided for each pixel, have generally been used as pixel circuits for active-matrix liquid crystal display apparatuses, electrophoretic display apparatuses, and so on.

However, problems such as those described below arise when applying common-inversion driving to an electrophoretic display apparatus that employs 1T1C pixel circuits.

FIG. 11 is a diagram illustrating a known 1T1C pixel circuit, and FIG. 12 is a diagram illustrating a potential waveform found in past pixel circuits.

With the pixel circuit illustrated in FIG. 11, a potential based on an image signal from a data line S is held in a holding capacitor 22 when a select transistor 21 turns on, and an electrophoretic element 26 is driven by a driving voltage based on the potential held by the holding capacitor 22, which holds the potential even after the select transistor 21 has turned off.

The electrophoretic element 26 has a property whereby leak current flows therein, the leak current being based on an applied DC voltage when such a DC voltage has been applied. Accordingly, the electrophoretic element 26 can be viewed as a resistance component connected between pixel electrodes 24 and a common electrode 25.

In FIG. 12, the solid line represents a common electrode potential applied to the common electrode 25, whereas the broken line represents the potential that appears in the pixel electrodes 24. When the common electrode potential is altered between a relatively low potential VL and a relatively high potential VH in order to execute common-inversion driving while the select transistor 21 is in an off state, delay dependent on the resistance component of the electrophoretic element 26 and the value of the holding capacitor occurs in the pixel electrode potential, and thus a potential waveform such as that indicated by the broken line appears in the pixel electrodes 24. As a result, a small potential difference arises for a short time between the pixel electrodes 24 and the common electrode 25 in the periods X1 and X2 shown in FIG. 12 (the hatched sections of FIG. 12), resulting in the driving of electrophoretic particles that do not have the voltage threshold, which causes the display state to change.

To be more specific, in the period X1, which corresponds to the rise of the common electrode waveform from the potential VL to the potential VH, the common electrode potential becomes relatively higher than the pixel electrode potential, and thus the negatively-charged particles (white particles) migrate toward the common electrode 25, resulting in an overall whitish display state.

Meanwhile, in the period X2, which corresponds to the fall of the common electrode waveform from the potential VH to the potential VL, the common electrode potential becomes relatively lower than the pixel electrode potential, and thus the positively-charged particles (black particles) migrate toward the common electrode 25, resulting in an overall blackish display state. In either case, there is a problem in that unintended display deterioration occurs.

Furthermore, the potential differences in the periods X1 and X2 illustrated in FIG. 12 occur in all pixels simultaneously. Accordingly, there has been a problem in that when the potential of the common electrode 25 is changed after having written the potential into the pixels while scanning the display unit by sequentially selecting scanning lines G, contrast differences have arisen within the display unit. In other words, although a sufficient amount of time for driving the electrophoretic element can be secured after writing the potential for the pixels in the display unit selected toward the beginning, with the pixels selected toward the end, the potential difference between the pixel electrodes 24 and the common electrode 25 drops if the common electrode potential is changed immediately after the potential has been written, and thus the electrophoretic element does not respond in a sufficient manner. Accordingly, a contrast distribution has arisen within the display unit. Furthermore, because differences in the voltage application history have arisen between the upper and lower portions of the display unit, there has also been the possibility of electrophoretic element deterioration.

This problem becomes particularly marked when rewriting the display in only a part of the display unit (partial rewriting). With bistable (image-stable) display elements such as electrophoretic elements, the display state can be maintained even without applying a voltage, and thus when, for example, moving a cursor, inputting handwriting using a stylus, and so on, driving only the regions of the display that are to be updated makes it possible to increase the speed of the display. However, because the common electrode 25 is generally provided in a solid state across the entire display unit, altering the common electrode potential causes image deterioration in regions that are not intended to be updated.

Thus electro-optical apparatuses provided with bistable display elements have had problems of image deterioration during display rewrites.

### SUMMARY

It is an advantage of some aspects of the invention to provide an electro-optical apparatus capable of high-quality display and a driving method for such an electro-optical apparatus.

An electro-optical apparatus according to an aspect of the invention includes an electro-optical layer sandwiched between a plurality of pixel electrodes and a common electrode, holding capacitors provided for each pixel corresponding to each of the pixel electrodes, a capacitance line connected to the electrode of the holding capacitor, and a control unit that controls the potentials of the pixel electrodes, the common electrode, and the capacitance line. The control unit executes, during an image display period in which an image is displayed in a display unit in which the pixels are arranged, a capacitance line potential change operation that changes the potential of the capacitance line in tandem with the potential of the common electrode so that the potential difference between the potential of the capacitance line and the potential of the common electrode decreases.

According to this configuration, the potential of one of the electrodes of the holding capacitor approaches the common electrode potential when the potential of the common electrode is changed; therefore, a change in the charge capacity of the holding capacitor can be reduced, and waveform delay in the pixel electrodes can be suppressed. Accordingly, it is possible to suppress the unintended application of a voltage to the electro-optical layer during common-inversion driving. As a result, image deterioration can be suppressed, and the occurrence of contrast differences in the display unit can be suppressed as well. Furthermore, it is possible to prevent differences in the voltage application history of the electro-optical layer from arising between the upper and lower portions of the display unit, thus making it possible to suppress the deterioration of the electro-optical layer.

It is preferable that in the capacitance line potential change operation, the control unit change the potential of the capacitance line in synchronization with the potential of the common electrode.

According to this configuration, the timing at which the capacitance line potential and the common electrode potential change is the same; this makes it possible to eliminate the period in which the waveform delay arises in the pixel electrodes, and makes it possible to prevent image deterioration with certainty.

It is preferable that in the capacitance line potential change operation, the control unit set the potentials of the common electrode and the capacitance line to the same potential.

According to this configuration, the range of fluctuation of the common electrode potential and the range of fluctuation of the capacitance line potential are the same; this makes it possible to eliminate a potential difference caused by waveform delay in the pixel electrodes, and makes it possible to prevent image deterioration with certainty.

It is preferable that prior to the capacitance line potential change operation, the control unit execute a discharge operation that discharges at least a part of the holding charge of the holding capacitor.

According to this configuration, the pixel electrode potential can be prevented from becoming extremely high when the capacitance line potential is changed, which makes it possible to prevent the breakdown of pixel switching elements, erroneous operation of the electro-optical layer, and so on.

It is preferable that in the discharge operation, all of the pixel electrodes be set together to the same potential.

According to this configuration, discharge operations can be completed in a short amount of time.

It is preferable that when changing the tone of some of the pixels in the display unit, the control unit execute the capacitance line potential changing operation.

According to this configuration, when performing partial rewriting operations, in which problems related particularly to image quality occur, image degradation in portions of the display unit aside from the partial rewriting region can be prevented.

It is preferable that the control unit executes the capacitance line potential changing operation when changing the tone of some of the pixels in the display unit, but holds the capacitance line at a constant potential when changing the tone of all of the pixels in the display unit.

According to this configuration, the image already displayed can be prevented from deteriorating during the partial rewriting operations, and operations for rewriting the entire screen can be realized with low power consumption and at high speed.

It is preferable for the common electrode and the capacitance line to be connected.

According to this configuration, a potential can be supplied to the common electrode and the capacitance line using a single driving circuit, which makes it possible to implement an electro-optical apparatus having a simple configuration.

It is preferable for the common electrode and the capacitance line to be insulated from each other.

According to this configuration, a driving circuit for supplying a potential to the common electrode and a driving circuit for supplying a potential to the capacitance line can be provided separately from each other, thereby making it possible to avoid adding a large load on the driving circuits.

It is preferable for the electro-optical apparatus to further include a capacitance line driving circuit connected to the capacitance line and a common electrode driving circuit connected to the common electrode, and for the capacitance line driving circuit to have a switch circuit that switches among multiple potentials to be supplied to the capacitance line, and for the common electrode driving circuit to have a waveform generation circuit that generates a potential waveform to be inputted into the common electrode and a current amplification circuit connected to the waveform generation circuit.

According to this configuration, an arbitrary potential can be supplied to the common electrode with sufficient current supply capabilities, and miniaturization and low power consumption can be realized in the capacitance line driving circuit.

It is preferable that during an image deletion operation for changing the display unit to a single tone, the control unit execute a potential input operation that inputs a first potential into the common electrode and the capacitance line and inputs a second potential that is different from the first potential into the pixel electrodes, and a boosting operation that boosts the voltage applied to the electro-optical layer by inputting a third potential into the capacitance line.

In the case where the common electrode and the capacitance line are insulated from each other, respectively different potentials can be inputted thereto. For example, in the aforementioned configuration, during image deletion operations, the potential of the pixel electrodes connected to the holding capacitor is changed by changing the potential of the capacitance line after potentials have been supplied to the pixel electrodes and the common electrode; through this, the voltage applied to the electro-optical layer can be increased. Accordingly, an electro-optical apparatus that is capable of quickly executing image deletion operations can be realized without providing a high-potential power source. In addition, compared to the case where the aforementioned high-voltage that is to be applied to the electro-optical layer is directly applied from the exterior, the potentials inputted to the common electrode, pixel electrodes, or capacitance line can be kept low, thereby making it possible to reduce the power consumed by the electro-optical apparatus as a whole.

It is preferable for the third potential to be approximately equal to the second potential. According to this configuration, a voltage that is approximately double the voltage during the potential input operations can be applied to the electro-optical layer due to the boosting operation. In addition, because only two types of potentials, or the first and second potentials, need to be prepared for the power sources, a power source having a simple configuration can be realized.

It is preferable for the electro-optical element to be an electrophoretic element. According to this configuration, it is possible to provide an electrophoretic display apparatus having superior display quality.

A driving method for an electro-optical apparatus according to an aspect of the invention is a driving method for an electro-optical apparatus that has an electro-optical layer sandwiched between a plurality of pixel electrodes and a common electrode, holding capacitors provided for each pixel corresponding to each of the pixel electrodes, and a capacitance line connected to the electrode of the holding capacitor; the method includes a process of changing, during an image display period in which an image is displayed in a display unit in which the pixels are arranged, the potential of the capacitance line in tandem with the potential of the common electrode so that the potential difference between the potential of the capacitance line and the potential of the common electrode decreases.

According to this driving method, the potential of one of the electrodes of the holding capacitor approaches the common electrode potential when the potential of the common electrode is changed; therefore, a change in the charge capacity of the holding capacitor can be reduced, and waveform delay in the pixel electrodes can be suppressed. Accordingly, it is possible to suppress the unintended application of a voltage to the electro-optical layer during common-inversion driving. As a result, image deterioration can be suppressed, and contrast differences in the display unit can be suppressed as well. Furthermore, it is possible to prevent differences in the voltage application history of the electro-optical layer from arising between the upper and lower portions of the display unit, thus making it possible to suppress the deterioration of the electro-optical layer.

It is preferable for the driving method to further include a process of discharging at least a part of the holding charge of the holding capacitor prior to the process of the changing of the potential of the capacitance line.

According to this driving method, the pixel electrode potential can be prevented from becoming extremely high when the capacitance line potential is changed, which makes it possible to prevent the breakdown of pixel switching elements, erroneous operation of the electro-optical layer, and so on.

It is preferable that in the process of discharging, all of the pixel electrodes be set together to the same potential.

According to this driving method, discharge operations can be completed in a short amount of time.

It is preferable for the capacitance line potential changing operation to be executed when changing the tone of some of the pixels in the display unit, but for the capacitance line to be held at a constant potential when changing the tone of all of the pixels in the display unit.

According to this driving method, the image already displayed can be prevented from deteriorating during the partial rewriting operations, and operations for rewriting the entire screen can be realized with low power consumption and at high speed.

An electronic device according to the invention includes the electro-optical apparatus described above.

According to this configuration, it is possible to provide an electronic device equipped with a display unit having superior display quality.

### BRIEF DESCRIPTION OF THE DRAWINGS

The invention will be described with reference to the accompanying drawings, wherein like numbers reference like elements.

FIG. 1 is a diagram illustrating the overall configuration of an electrophoretic display apparatus according to an embodiment of the invention.

FIG. 2 is a block diagram illustrating a circuit in a display according to an embodiment of the invention.

FIGS. 3A, 3B, and 3C are diagrams illustrating details of primary elements of an electrophoretic display apparatus.

FIG. 4 is a partial cross-sectional view of a display.

FIG. 5 is a schematic cross-sectional view of a microcapsule.

FIG. 6 is a flowchart for a driving method according to an embodiment of the invention.

FIGS. 7A, 7B, and 7C are descriptive diagrams illustrating state transitions of a display unit in a driving method according to an embodiment of the invention.

FIG. 8 is a timing chart corresponding to FIG. 6.

FIG. 9 is a diagram illustrating a variation of a pixel circuit.

FIGS. 10A and 10B are diagrams illustrating an example of an electronic device.

FIG. 11 is a diagram illustrating a past pixel circuit.

FIG. 12 is a diagram illustrating a potential waveform in a past electrophoretic display apparatus.

FIGS. 13A and 13B are flowcharts illustrating whiteout and blackout operations.

### DESCRIPTION OF EXEMPLARY EMBODIMENTS

Hereinafter, an electro-optical apparatus according to the invention will be described using the diagrams.

Note that the scope of the invention is not intended to be limited to the embodiments described hereinafter, and various modifications can be made within this scope without departing from the technical spirit of the invention. Furthermore, to facilitate understanding of the various structures, the scale, numbers, and so on of the various structures depicted in the drawings differ from those of the actual structures.

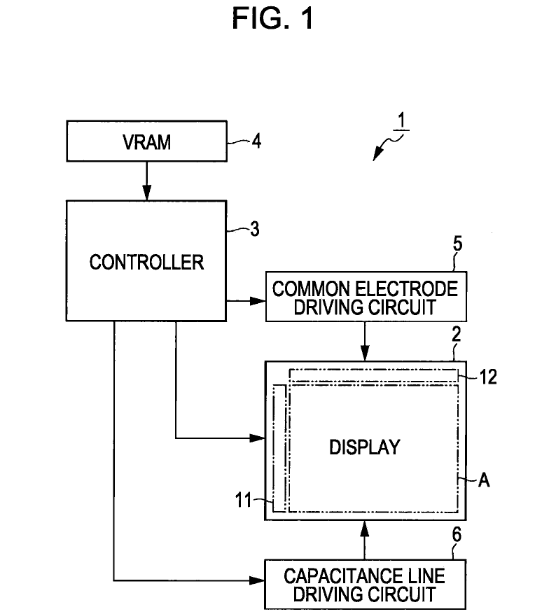

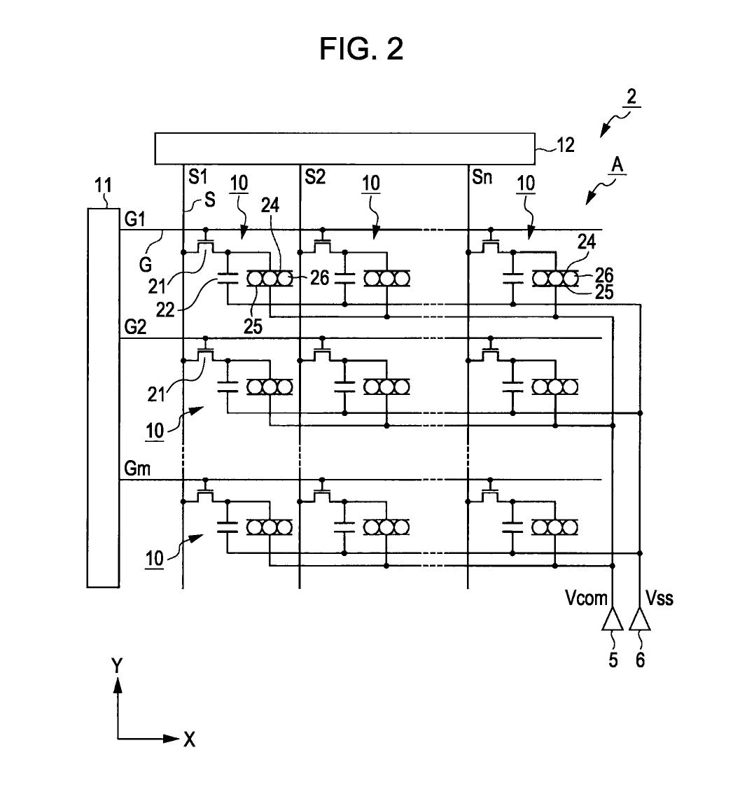

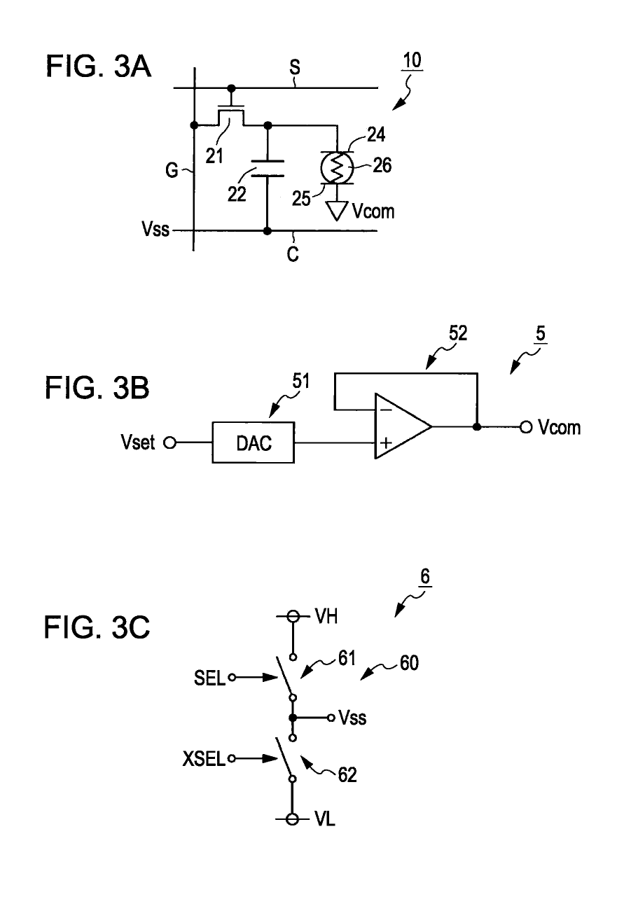

FIG. 1 is a diagram illustrating the overall configuration of an electrophoretic display apparatus serving as an embodiment of an electro-optical apparatus according to an aspect of the invention. FIG. 2 is a block diagram illustrating a circuit in a display according to this embodiment. FIGS. 3A, 3B, and 3C are diagrams illustrating details of primary elements of the electrophoretic display apparatus.

An electrophoretic display apparatus 1 shown in FIG. 1 includes a display 2, a controller 3, a VRAM (Video Random Access Memory) 4, a common electrode driving circuit 5, and a capacitance line driving circuit 6.

The display 2 receives control signals from the controller 3 and a voltage supply from the common electrode driving circuit 5, and displays an image. A display unit A, a scanning line driving circuit 11, and a data line driving circuit 12 are formed in the display 2.

The controller 3 is the control unit of the electrophoretic display apparatus 1; the controller 3 receives image data to be displayed from the VRAM 4 and controls the display 2 to display images. To be more specific, the controller 3 controls the common electrode driving circuit 5 and the capacitance line driving circuit 6, as well as the scanning line driving circuit 11 and the data line driving circuit 12 provided in the display 2, and so on. The controller 3 supplies control signals including, for example, a clock signal, timing signals such as a start pulse, and image data to the various circuits.

The VRAM 4 is used to temporarily store one image's worth of data to be displayed next in the display unit, from image data stored in a storage unit such as a flash memory or the like (not shown in the drawings).

The common electrode driving circuit 5 is connected to a common electrode 25 provided in the display 2 (see FIG. 2), and supplies the common electrode 25 with an arbitrary common electrode potential Vcom.

The capacitance line driving circuit 6 is connected to a capacitance line C provided in the display 2 (see FIG. 2), and supplies the capacitance line C with an arbitrary capacitance line potential Vss.

As shown in FIG. 2, a plurality of scanning lines G1, G2, and so on up to Gm, extending in the x-axis direction, and a plurality of data lines S1, S2, and so on up to Sn, extending in the y-axis direction, are formed in the display unit A of the display 2. Pixels 10 are formed at locations corresponding to the intersections of the scanning lines G and the data lines S, and a scanning line G and a data line S are connected to each of the pixels 10. The pixels 10 are arranged in matrix form, with m pixels disposed in the y-axis direction, and n pixels disposed in the x-axis direction.

Furthermore, the common electrode 25 connected to the common electrode driving circuit 5 and the capacitance line C connected to the capacitance line driving circuit 6 are formed in the display unit A.

Note that in the present specification, when expressing the wiring as a whole, or when the wiring order (location) is not specifically indicated, the expressions “scanning lines G” and “data lines S” will be used.

Here, FIG. 3A is a pixel circuit diagram according to this embodiment.

A select transistor 21 serving as a pixel switching element, a holding capacitor 22, a pixel electrode 24, a common electrode 25, and an electrophoretic element 26 (photo-electric layer) are formed in each pixel 10.

The select transistor 21 is configured of an N-type MOS (Metal Oxide Semiconductor) TFT. A scanning line G and a data line S are connected to the gate terminal and source terminal, respectively, of the select transistor 21, whereas one of the electrodes of the holding capacitor 22 and the pixel electrode 24 are connected to the drain terminal of the select transistor 21.

The holding capacitor 22 is formed on an element substrate, mentioned later, and is configured of an electrode pair disposed on opposing sides of a dielectric film. One of the electrodes of the holding capacitor 22 is connected to the select transistor 21, and the other electrode thereof is connected to the capacitance line C. An image signal written via the select transistor 21 is held for a certain period by the holding capacitor 22.

The electrophoretic element 26 is configured of a plurality of microcapsules, each of which contains electrophoretic particles.

The scanning line driving circuit 11 shown in FIG. 2 is connected to the scanning lines G formed in the display unit A, and is connected to the pixels 10 in corresponding pixel rows via the scanning lines G.

The scanning line driving circuit 11 sequentially supplies pulse-form selection signals to each of the scanning lines G1, G2, and so on up to Gm based on a timing signal supplied from the controller 3, sequentially putting the scanning lines G into a selected state, exclusively, on a line-by-line basis. “Selected state” refers to a state in which the select transistor 21 connected to the scanning line G is on.

The data line driving circuit 12 is connected to the data lines S formed in the display unit A, and is connected to the pixels 10 in corresponding pixel columns via the data lines S.

The data line driving circuit 12 supplies an image signal to the data lines S1, S2, and so on up to Sn based on a timing signal supplied from the controller 3. To simplify the descriptions of this embodiment, the image signal here takes on one of two potential values: a high-level potential VH (for example, 15 V), or a low-level potential VL (or example, 0 V). Note also that in this embodiment, the low-level image signal (potential VL) is supplied to pixels 10 that are to display white, whereas the high-level image signal (potential VH) is supplied to pixels 10 that are to display black.

A common electrode potential Vcom is supplied to the common electrode 25 from the common electrode driving circuit 5. In this embodiment, the common electrode driving circuit 5 is configured, as shown in FIG. 3B, so as to include a DAC 51 (waveform generation circuit) and an operational amplifier 52 (current amplification circuit). The DAC 51 is a D/A converter that generates a potential waveform from an inputted setting signal Vset. The potential waveform outputted from the DAC 51 undergoes current amplification in the operational amplifier 52, and is then supplied to the common electrode 25. Because an arbitrary potential waveform can be generated by the DAC 51, the common electrode potential Vcom can be altered in the common electrode driving circuit 5 based on the tone to be written into the pixel 10.

Note that to simplify the descriptions, the common electrode potential Vcom will be discussed in the descriptions of a driving method (mentioned later) as taking on one of two values, or the low-level potential VL (for example, 0 V) and the high-level potential VH (for example, 15 V).

A capacitance line potential Vss is supplied to the capacitance line C from the capacitance line driving circuit 6. In this embodiment, the capacitance line driving circuit 6 is configured, as shown in FIG. 3C, as a switch circuit 60 that includes two switching elements 61 and 62 that operate exclusively. The switching element 61 switches the potential supplied from the high-level (VH) power source between output terminals. Meanwhile, the switching element 62 switches the potential supplied from the low-level (VL) power source between output terminals. A selection signal SEL and inverted selection signal XSEL are inputted into the control terminals of the switching elements 61 and 62, respectively, and thus the switching element 61 and the switching element 62 operate exclusively.

Note that although the low-level potential VL (for example, 0 V) or the high-level potential VH (for example, 15 V) are described in this embodiment as being outputted as the capacitance line potential Vss to simplify the descriptions, changing the potentials of the power sources connected to the switching elements 61 and 62 make it possible to output an arbitrary capacitance line potential Vss.

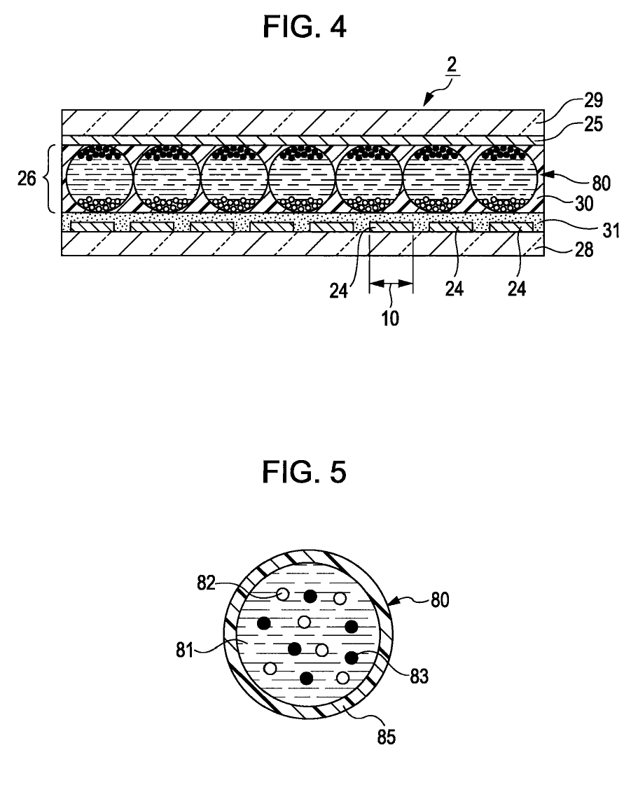

FIG. 4 is a partial cross-sectional view of a display.

As shown in FIG. 4, the display 2 is configured so that the electrophoretic element 26 is sandwiched between an element substrate 28 and an opposing substrate 29. Note that in this embodiment, the descriptions assume that images are displayed on the opposing substrate 29.

The element substrate 28 is a substrate configured of, for example, glass, plastic, or the like. The aforementioned select transistors 21, holding capacitors 22, scanning lines G, data lines S, capacitance line C, and so on are formed upon the element substrate 28 in a layered structure. Multiple pixel electrodes 24 are formed in a matrix on the upper layer of this layered structure.

The opposing substrate 29 is a transparent substrate configured of, for example, glass, plastic, or the like. The common electrode 25 is formed, in the side of the opposing substrate 29 that faces the element substrate 28, in a solid state opposing the a plurality of pixel electrodes 24. The common electrode 25 is formed of a transparent conductive material such as, for example, magnesium-silver (MgAg), indium tin oxide (ITO), indium zinc oxide, or the like.

The electrophoretic element 26 is configured of a plurality of microcapsules 80, each of which contains electrophoretic particles. The plurality of microcapsules 80 are fixed to the element substrate 28 and the opposing substrate 29 by a binder 30 composed of, for example, a resin or the like, and an adhesive layer 31.

Note that the display 2 is manufactured by laminating, using the adhesive layer 31, an electrophoretic sheet formed by fixing the electrophoretic element 26 to the opposing substrate 29 side in advance using the binder 30, to the element substrate 28 in which the pixel electrodes 24 and so on have been formed and that has been manufactured separately from the electrophoretic sheet.

The microcapsules 80 are sandwiched between the pixel electrodes 24 and the common electrode 25, and one or more microcapsules 80 are disposed within a single pixel 10 (to rephrase, for a single pixel electrode 24).

FIG. 5 is a schematic cross-sectional view of a microcapsule.

As shown in FIG. 5, the microcapsule 80 has a structure in which a casing 85 is filled with a carrier fluid 81, a plurality of white particles 82, and a plurality of black particles 83. Each microcapsule 80 is formed in a sphere-shaped having a particle diameter of, for example, approximately 50 μm. Note that the white particles 82 and the black particles 83 are examples of “electrophoretic particles” according to an aspect of the invention.

The casing 85 functions as the casing of the microcapsule 80, and is formed of a translucent polymer resin, such as an acrylic resin including polymethylmethacrylate and polyethyl methacrylate, urea resin, Gum Arabic, gelatin, or the like.

The carrier fluid 81 is a medium in which the white particles 82 and the black particles 83 are dispersed throughout within the microcapsule 80 (to rephrase, inside of the casing 85). Water, alcohol solvents (methanol, ethanol, isopropanol, butanol, octanol, methyl cellosolve, and so on), esters (ethyl acetate, butyl acetate, and so on), ketones (acetone, methyl ethyl ketone, methyl isobutyl ketone, and so on), aliphatic hydrocarbons (pentane, hexane, octane, and so on), alicyclic hydrocarbons (cyclohexane, methylcyclohexane, and so on), aromatic hydrocarbons (benzene, toluene, benzenes having long-chain alkyl groups (xylene, hexylbenzene, heptylbenzene, octylbenzene, nonylbenzene, decylbenzene, undecylbenzene, dodecylbenzene, tridecylbenzene and tetradecylbenzene)), halogenated hydrocarbons (methylene chloride, chloroform, carbon tetrachloride, 1,2-dichloroethane, and so on), carboxylic acid salt, and so on can be given as examples of the carrier fluid 81; other oils may be employed as well. These materials may be used alone or as mixtures, and surface-active agents may be added thereto as well.

The white particles 82 are particles (polymers or colloids) configured of a white pigment such as, for example, titanium dioxide, hydrozincite, antimonous oxide, or the like, and are used in, for example, a negatively-charged state. The black particles 83, meanwhile, are particles (high-polymers or colloids) configured of a black pigment such as, for example, aniline black, carbon black, or the like, and are used in, for example, a positively-charged state.

Charge control agents configured of particles of electrolytes, surface-active agents, metallic soaps, resins, rubbers, oils, varnishes, compounds, or the like, dispersants such as titanium coupling agents, aluminum coupling agents, and silane coupling agents, lubricant agents, stabilizing agents, and so on may be added to these pigments as necessary.

In addition, red, green, blue, or other such pigments may be used instead of the white particles 82 and the black particles 83. Based on such a configuration, it is possible to display red, green, blue, or other such colors in the display unit.

Driving Method

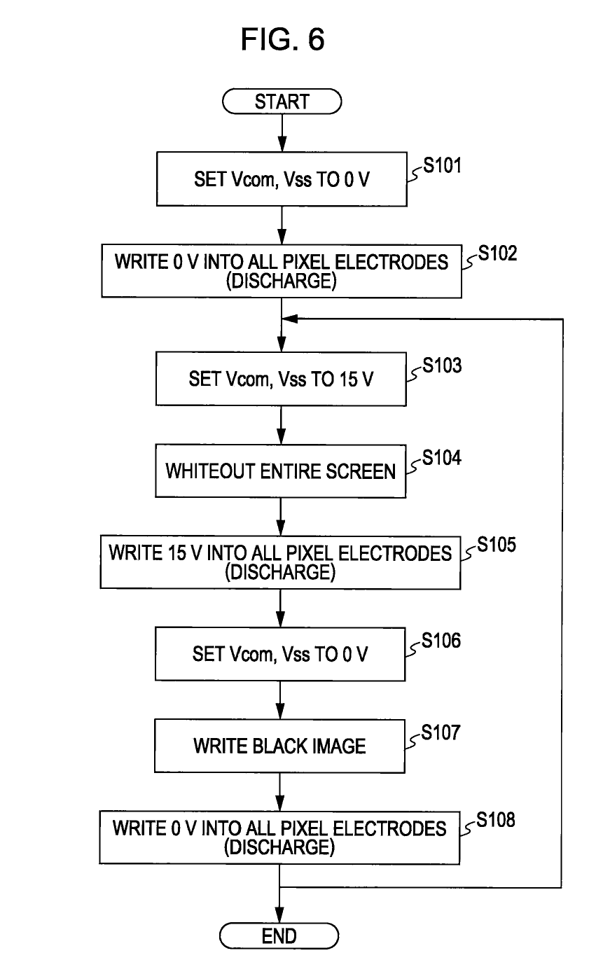

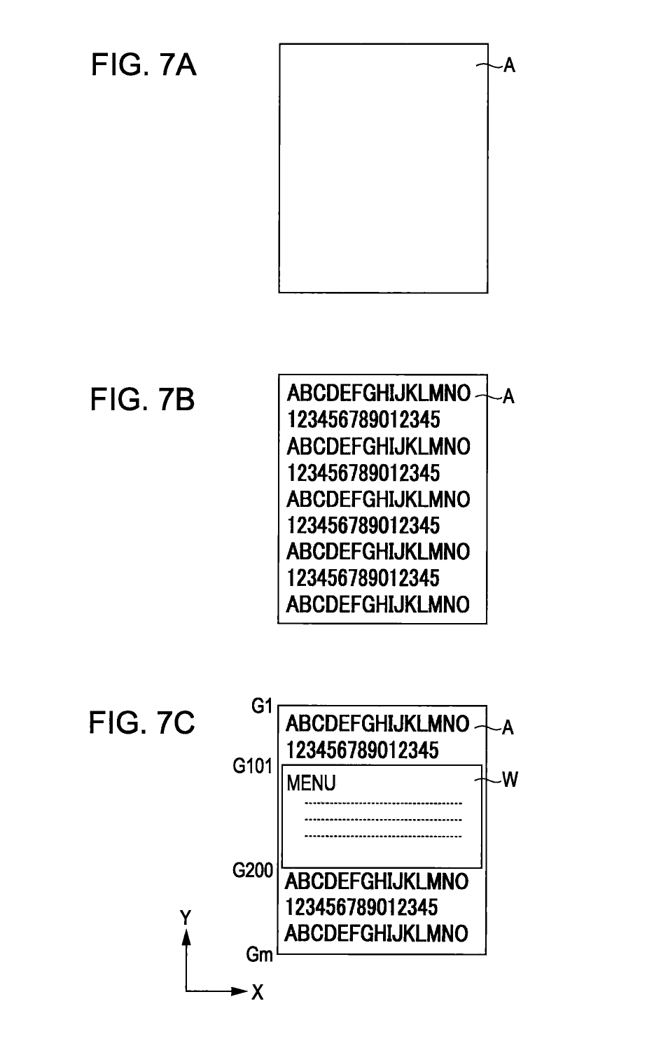

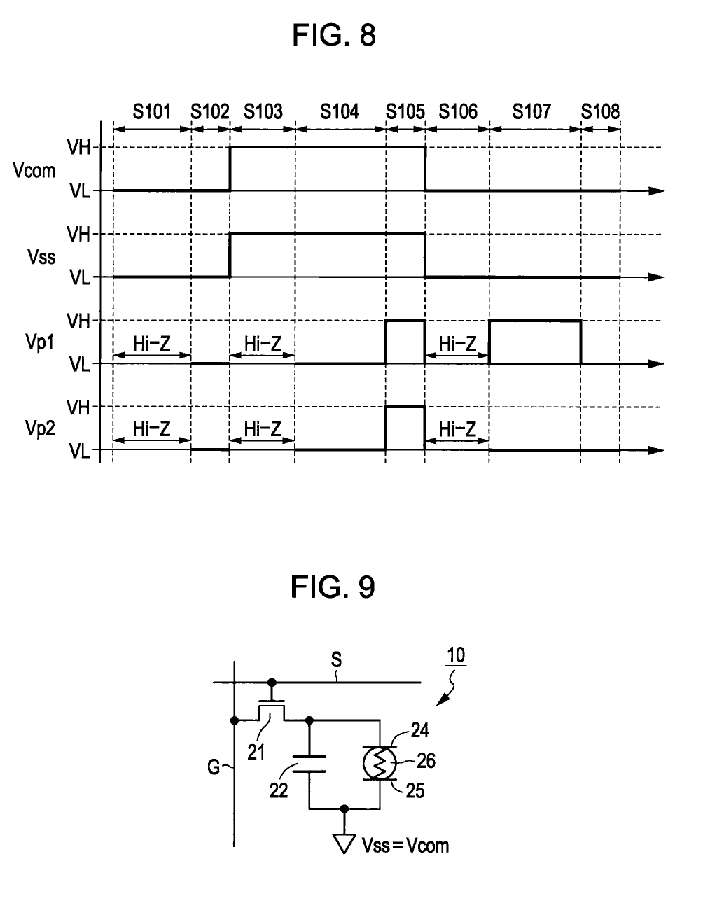

FIG. 6 is a flowchart illustrating the flow of processing in a driving method for an electrophoretic display apparatus according to this embodiment. FIGS. 7A, 7B, and 7C are descriptive diagrams illustrating state transitions of the display unit A in the driving method according to this embodiment. FIG. 8 is a timing chart corresponding to FIG. 6.

Note that in FIG. 8, “Vp1” indicates the potential inputted into the pixel electrodes 24 of the pixels 10 that display black in process S107, whereas “Vp2” indicates the potential inputted into the pixel electrodes 24 of the pixels 10 that display white in process S107.

Note also that the descriptions of this embodiment will proceed assuming that of the electrophoretic particles, the white particles 82 are negatively charged, whereas the black particles 83 are positively charged. Accordingly, when driving is performed by inputting one of the potential VL (0 V) and the potential VH (15 V) into the pixel electrode 24 and the common electrode 25, if Vcom is set to the high-level (VH; 15 V), pixels 10 for which the pixel electrode 24 is at low-level (VL; 0 V) display white, and pixels 10 for which the pixel electrode 24 is at high-level (VH; 15 V) experience no change in their displays. On the other hand, if Vcom is set to the low-level (VL; 0 V), pixels 10 for which the pixel electrode 24 is at high-level (VH; 15 V) display black, and pixels 10 for which the pixel electrode 24 is at low-level (VL; 0 V) experience no change in their displays.

The driving method of this embodiment relates to image display operations whereby an image is caused to be displayed in the display unit A through the processes S101 to S108 shown in FIG. 6. Accordingly, the processes S101 to S108 shown in FIG. 6 are sequentially executed when, for example, the controller 3 has received a display driving start command as a result of a user pressing a button (not shown).

First, prior to the image display operations, operations for discharging the holding capacitor 22 are executed in processes S101 and S102.

In process S101, the common electrode potential Vcom and the capacitance line potential Vss are set to the low-level (VL; 0 V), as shown in FIG. 8. To be more specific, 0 V (VL) is inputted into the common electrode 25 from the common electrode driving circuit 5, and 0 V (VL) is inputted into the capacitance line C from the capacitance line driving circuit 6, under the control of the controller 3.

After this, in process S102, all of the pixel electrodes 24 in the display unit A are inputted with a low-level potential VL. To be more specific, under the control of the controller 3, scanning lines G are sequentially selected by the scanning line driving circuit 11, and an image signal of the potential VL supplied from the data line driving circuit 12 is inputted into the pixel electrodes 24 of the pixels 10 connected to the selected scanning lines G.

Through the above operations, both electrons of the holding capacitors 22 of all pixels 10 are set to the low-level (VL), thereby discharging the charge accumulated in the holding capacitors 22.

Note that in process S102, the potential input into the pixel electrodes 24 may be sequentially executed on a line-by-line basis (one scanning line G at a time) as described above, or the potential may be inputted into all the pixel electrodes 24 by turning the select transistors 21 of all the pixels 10 on at once. Using such a driving method makes it possible to reduce the amount of time required for discharge operations. When using this driving method, the scanning line driving circuit 11 is provided with an enable function for collectively selecting all the scanning lines G.

Once the aforementioned discharge operations have ended, the image display operations indicated in processes S103 to S108 are executed.

First, in process S103, the common electrode potential Vcom and the capacitance line potential Vss are set to the high-level (VH). Next, in process S104, all of the pixel electrodes 24 in the display unit A are inputted with the low-level potential (VL). By doing so, the pixel electrodes 24 have a relatively low potential, and the common electrode 25 has a relatively high potential. Through this, in process S104, the white particles 82 of the electrophoretic element 26 are pulled toward the common electrode 25 side, and as a result, the entirety of the display unit A displays white, as shown in FIG. 7A.

Next, in process S105, the high-level potential (VH) is inputted into all the pixel electrodes 24. Through this, the electrodes of the holding capacitors 22 that are connected to the pixel electrodes 24 in all the pixels 10 enter the high-level (VH). Then, because the capacitance line potential Vss has been set to the high-level (VH) in process S103, both of the electrodes of the holding capacitor 22 enter the high-level (VH), and the charge accumulated in the holding capacitor 22 in process S104 is discharged.

Next, in process S106, the common electrode potential Vcom and the capacitance line potential Vss are set to the low-level (VL). After this, in process S107, a black image is written. To be more specific, in process S107, image data corresponding to the display image illustrated in FIG. 7B is inputted into the controller 3. Under the control of the controller 3, image signals are inputted into the pixels 10 of the display unit A by the scanning line driving circuit 11 and the data line driving circuit 12.

As shown in FIG. 8, in pixels 10 that display black, the potential Vp1 of the pixel electrodes 24 is set to high-level (VH). Through this, the black particles 83 of the electrophoretic element 26 are pulled toward the common electrode 25 side as a result of the potential difference between the pixel electrodes 24 (high-level) and the common electrode 25 (low-level), and thus the pixels 10 display black.

On the other hand, in pixels 10 that display white, the potential Vp2 of the pixel electrodes 24 is set to low-level (VL). As a result, the pixel electrodes 24 and the common electrode 25 are at the same potential, and thus the electrophoretic element 26 does not operate, thereby maintaining the white display.

Through the operations described thus far, an image made up of pixels 10 displaying white and pixels 10 displaying black is formed in the display unit A, as shown in FIG. 7B.

Next, in process S108, the low-level potential (VL) is inputted into all the pixel electrodes 24. Through this, the electrode of the holding capacitor 22 that is connected to the pixel electrode 24 in all the pixels 10 goes to low-level (VL). Then, because the capacitance line potential Vss has been set to the low-level (VL) in process S106, both of the electrodes of the holding capacitor 22 go to low-level (VL), and the charge accumulated in the holding capacitor 22 in process S107 is discharged.

Through the above operations, and image based on arbitrary image data can be displayed in the display unit A.

Note that in the case where the display image of the display unit A is to be updated, the discharging of the holding capacitor 22 has been completed in process S108, and therefore processes S103 to S108, shown in FIG. 6, may simply be re-executed.

In addition, by performing the image display operations of processes S104 and S107 on target regions only, the driving method of this embodiment is also compatible with partial rewriting operations, in which only a partial region of the display unit A is rewritten.

Such partial rewriting operations will be described briefly hereinafter. Hereinafter, descriptions will be given regarding a case in which the display state transits from that shown in FIG. 7B to the state shown in FIG. 7C (a state in which a window W is displayed).

In the example shown in FIG. 7C, the region in which the window W is displayed as a range spanning from lines 101 to 200 of the scanning lines G. In the partial rewriting operations, this range spanning from lines 101 to 200 is set as a partial rewriting region. Then, because the procedure for displaying the image illustrated in FIG. 7B has advanced as far as the completion of process S108, the partial rewriting operation is performed by re-executing the operation starting with process S103.

First, in process S103, the common electrode potential Vcom and the capacitance line potential Vss are set to the high-level (VH).

Next, in process S104, the controller 3 supplies a control signal, indicating that the starting line is line 101 and ending line is line 200, to the scanning line driving circuit 11. In response to this, the scanning line driving circuit 11 sequentially selects the scanning lines G from line G101 to line G200. Then, under the control of the controller 3, the data line driving circuit 12 supplies a low-level (VL) image signal to the data lines S in synchronization with the selection operations performed by the scanning line driving circuit 11. Through this, the partial rewriting region spanning from lines 101 to 200 is caused to display white, thereby clearing the image that was displayed there up until that point.

Note that in process S104, the scanning lines G1 to G100 and G201 to Gm may be put into a non-selected state by the scanning line driving circuit 11 while the scanning lines G101 to G200 are collectively put into the selected state. If a low-level (VL) image signal is supplied to the scanning lines G from the data line driving circuit 12 in this state, the pixels 10 belonging to the scanning lines G101 to G200 can be collectively inputted with the image signal.

Next, after the discharge operations for the holding capacitor 22 in process S105, the common electrode potential Vcom and capacitance line potential Vss are set to low-level (VL) in process S106.

After this, in process S107, image data corresponding to the window W is inputted into the controller 3. The controller 3 supplies a control signal, indicating that the starting line is line 101 and ending line is line 200, to the scanning line driving circuit 11. The scanning line driving circuit 11 sequentially selects the scanning lines G from line G101 to line G200, and places the other scanning lines, or lines G1 to G100 and G201 to Gm, into a non-selected state. Then, under the control of the controller 3, a low-level (VL) or high-level (VH) image signal is supplied to the data lines S from the data line driving circuit 12 in synchronization with the selection operations performed by the scanning line driving circuit 11. Through this, the pixels 10 in the partial rewriting region spanning from lines 101 to 200 can be caused to display white or black, thereby making it possible to display the window W in the partial rewriting region.

As has been described in detail as far, with the driving method for an electrophoretic display device according to this embodiment, the capacitance line potential Vss is changed to the same potential as the common electrode potential Vcom at the same time the common electrode potential Vcom is changed (processes S103 and S106). Through this, the charge capacity of the holding capacitor 22 does not change when the common electrode potential Vcom is changed, and therefore waveform delay in the pixel electrode 24, as illustrated in FIG. 12, can be suppressed. Accordingly, it is possible to suppress the unintended application of a voltage to the electrophoretic element 26 during common-inversion driving. As a result, image deterioration can be suppressed, and contrast differences between the upper and lower portions of the display unit A (the y-axis direction shown in FIG. 2; the scanning direction) can be suppressed as well. Furthermore, it is possible to prevent differences in the voltage application history of the electrophoretic element 26 from arising between the upper and lower portions of the display unit A, thus making it possible to suppress the deterioration of the electrophoretic element 26.

In addition, in this embodiment, after operations for displaying an image in the display unit A have been performed in processes S104 and S107, the holding capacitor 22 is discharged in processes S105 and S108. If the capacitance line potential Vss is changed while the holding capacitor 22 is in a charged state, the charged potential of the holding capacitor 22 will be added to the potential of the pixel electrode 24. As a result, the pixel electrode 24 will reach an unintended high potential, exceeding the withstanding voltage of the select transistor 21, which can cause the select transistor 21 to break down. Accordingly, in this embodiment, the discharge operations are performed prior to changing the capacitance line potential Vss, thereby preventing a change in the potential of the pixel electrodes 24 when the capacitance line potential Vss is changed.

Note that in the discharge operations, the holding capacitor 22 need not be completely discharged (set to a potential difference of 0 V); it is acceptable for potential of the pixel electrode 24 at the time of the capacitance line potential Vss change to be set so as not to exceed the withstanding voltage of the select transistor 21. For example, in process S105, it is assumed that high-level (VH; 15 V) is inputted into all the pixel electrodes 24, but in the case where the withstanding voltage of the select transistor 21 is comparatively high, a potential of, for example, approximately 10 V may be inputted.

In addition, according to the driving method of this embodiment, when performing the partial rewriting operations in which only a partial region of the display unit A is rewritten, the capacitance line potential Vss is changed to the same potential as the common electrode potential Vcom when the common electrode potential Vcom is changed (processes S103 and S106).

With the partial rewriting operations, the pixel electrodes 24 outside of the partial rewriting region are in a high-impedance state (Hi-Z) with the select transistor 21 off; therefore, waveform delay occurs in the pixel electrodes 24 when the common electrode potential Vcom is changed, and thus the portions of the display unit A outside of the partial rewriting region become whitish or blackish. Because this deteriorated display is continuously displayed until those regions are rewritten, this poses a problem in terms of display quality.

However, with the driving method of this embodiment, the capacitance line potential Vss is changed along with the common electrode potential Vcom, which makes it possible to prevent waveform delay in the pixel electrodes 24 when the common electrode potential Vcom is changed, and makes it possible to effectively prevent image deterioration in the portions of the display unit A aside from the partial rewriting region.

Furthermore, with the electrophoretic display apparatus 1 of this embodiment, the common electrode driving circuit 5 that supplies the potential to the common electrode 25 and the capacitance line driving circuit 6 that supplies the potential to the capacitance line C are implemented as separate circuits. Because the common electrode 25 and the capacitance line C are common for all the pixels 10, implementing a configuration in which the potential is supplied from a single driving circuit increases the load on the driving circuit, particularly in the case of large-sized panels. On the other hand, implementing these circuits as separate circuits, as in this embodiment, makes it possible to distribute the load and supply the potential in a stable manner, even in the case of large-sized panels.

Although the capacitance line potential Vss is described as being changed in synchronization with the common electrode potential Vcom in this embodiment, it should be noted that the timing at which the capacitance line potential Vss is changed may be skewed from the timing at which the common electrode potential Vcom is changed. In other words, the capacitance line potential Vss may be changed before or after changing the common electrode potential Vcom. Implementing such a driving method makes it possible to skew the timings at which the common electrode driving circuit 5 and the capacitance line driving circuit 6 operate, thereby making it possible to reduce the peak current of the electrophoretic display apparatus 1.

However, the waveform delay in the pixel electrode 24 illustrated in FIG. 12 occurs during the period spanning from after the common electrode potential Vcom has been changed to when the capacitance line potential Vss is changed, and thus the permissible range for this timing skew is a range in which display deterioration caused by waveform delay will not occur.

In addition, in this embodiment, although the common electrode driving circuit 5 is described as being configured including a DAC 51 and an operational amplifier 52, the capacitance line driving circuit 6 is configured of a switch circuit 60.

While it is desirable to be able to set the potential of the common electrode 25 to an arbitrary potential for tone driving, operational amplifiers having sufficient current supply capabilities are large and consume large amounts of power, and thus it is difficult to provide an amplifier that is both small and consumes small amounts of power. However, the capacitance line potential Vss need not be equal to the common electrode potential Vcom, and as long as the potential difference between the pixel electrodes 24 and the common electrode 25 occurring during common-inversion driving is within a small range that does not cause the electrophoretic element 26 to be driven, the capacitance line potential Vss may be slightly different than the common electrode potential Vcom.

Accordingly, in this embodiment, the common electrode driving circuit 5 is provided with the DAC 51 and the operational amplifier 52, making it possible to supply an arbitrary potential to the common electrode 25 with sufficient current supply capabilities, whereas the capacitance line driving circuit 6 is configured of a switch circuit 60, which can be easily miniaturized. Accordingly, a configuration that meets the required functions for each circuit while also realizing miniaturization and low power consumption is implemented.

Although this embodiment describes linking the capacitance line potential Vss with the common electrode potential Vcom both when performing rewrite operations for the entire screen and when performing partial rewrite operations, the invention is not limited thereto.

For example, a driving method in which the capacitance line potential Vss is set to a constant potential independent from the common electrode potential Vcom in operations for rewriting the entire screen in the capacitance line potential Vss and the common electrode potential Vcom are linked during partial rewrite operations may be employed.

Because the entire display of the display unit A is updated in the operations for rewriting the entire screen, a contrast difference between the upper and lower portions of the display unit A will not pose a problem in terms of display quality as long as that difference is within a permissible range. However, in partial rewriting operations, the image that is already being displayed experiences deterioration, thus posing a problem in terms of display quality. Accordingly, linking the capacitance line potential Vss with the common electrode potential Vcom only during the partial rewriting operations as described above makes it possible to suppress the amount of current consumed by parasitic capacitance charging when changing the potential of the capacitance line C.

In addition, in the case where the capacitance line potential Vss is not changed, the discharge operations described in processes S105 and S108 are unnecessary, thereby making it possible to further suppress the power consumed during the operations for rewriting the entire screen, and making it possible to improve the display speed.

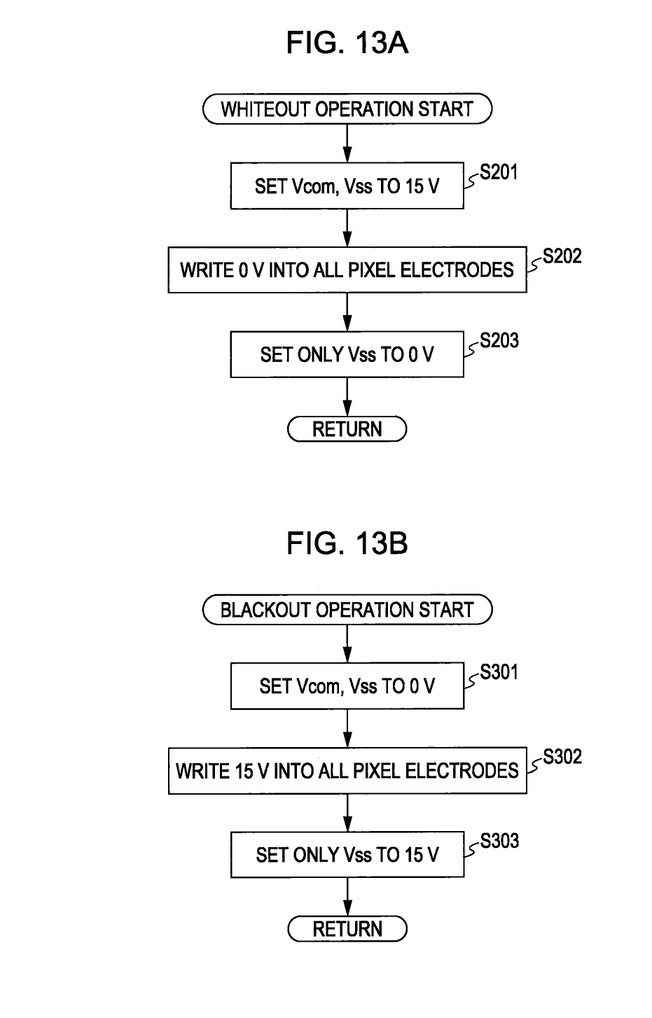

Furthermore, implementing a configuration in which the capacitance line potential Vss and the common electrode potential Vcom can be set independently (that is, the capacitance line C and the common electrode 25 are insulated from one another) has an advantage in that image deletion operations can be executed with efficiency. These image deletion operations will be described in detail hereinafter with reference to FIGS. 13A and 13B.

FIG. 13A is a flowchart illustrating a configuration for carrying out whiteout operations whereby the entirety of the display unit A displays white, whereas FIG. 13B is a flowchart illustrating a configuration for carrying out blackout operations whereby the entirety of the display unit A displays black.

Whiteout Operations

First, the whiteout operations indicated in FIG. 13A include process S201, in which the common electrode potential Vcom and the capacitance line potential Vss are set to 15 V; process S202, in which 0 V is written into all the pixel electrodes 24; and process S203, in which the capacitance line potential Vss is set to 0 V.

To be more specific, in process S201, 15 V (a first potential) is inputted into the common electrode 25, and in process S202, 0 V (a second potential) is inputted into the pixel electrodes 24. Through this, a potential that causes the pixels 10 to display white is inputted into all of the pixels 10 in the display unit A (a potential input operation). Meanwhile, in process S201, 15 V (the first potential) is inputted into the capacitance line C, and in process S202, 0 V (the second potential) is inputted into the pixel electrodes 24, thereby charging the holding capacitor 22.

Then, in this example, 0 V (the second potential) is inputted into the capacitance line C in process S203. When the potential of one of the electrodes of the holding capacitor 22 (the electrode connected to the capacitance line C) changes from 15 V to 0 V in this charged state, the potential of the other electrode of the holding capacitor 22 (the pixel electrode 24) drops almost 15 V as well, thus changing from 0 V to approximately −15 V.

At this time, the potential of the common electrode 25 is held at 15 V, and thus the potential difference between the pixel electrodes 24 and the common electrode 25 is approximately 30 V, resulting in approximately twice the potential difference (15V) as that occurring during the potential input operations (a boosting operation).

According to the whiteout operations described in this example, approximately double the voltage can be applied to electrophoretic element 26, and thus the image deletion operations can be executed in a short amount of time. These whiteout operations can be applied instead of the processes S103 and S104 described earlier with reference to FIG. 6. Employing the whiteout operations described in this example also makes it possible to reduce the amount of time required for the overall image display operations, thereby making it possible to implement high-speed image display operations.

Furthermore, in this example, there are two types of potentials, or the first potential (15 V) and the second potential (0 V), that are inputted into the pixel electrodes 24, the common electrode 25, and the capacitance line C, and are thus common with the two types of potentials used in the image display operations described earlier. Accordingly, it is not necessary to prepare a separate source potential in order to implement high-speed image deletion operations, and thus the operations can be implemented without complicating the power source configuration. Finally, the potential inputted into the common electrode 25, the pixel electrodes 24, or the capacitance line C can be suppressed to a lower potential than in the case where the voltage that is to be applied to the electrophoretic element 26 is applied directly from the exterior, as described in process S203; therefore, the overall power consumption of the electro-optical apparatus can be reduced.

Blackout Operations

Next, the blackout operations indicated in FIG. 13B include process S301, in which the common electrode potential Vcom and the capacitance line potential Vss are set to 0 V; process S302, in which 15 V is written into all the pixel electrodes 24; and process S303, in which the capacitance line potential Vss is set to 15 V.

To be more specific, in process S301, 0 V (the first potential) is inputted into the common electrode 25, and in process S302, 15 V (the second potential) is inputted into the pixel electrodes 24. Through this, a potential that causes the pixels 10 to display black is inputted into all of the pixels 10 in the display unit A (a potential input operation). Meanwhile, in process S301, 0 V (the first potential) is inputted into the capacitance line C, and in process S302, 15 V (the second potential) is inputted into the pixel electrodes 24, thereby charging the holding capacitor 22.

Then, in this example, 15 V (the second potential) is inputted into the capacitance line C in process S303. When the potential of one of the electrodes of the holding capacitor 22 (the electrode connected to the capacitance line C) changes from 0 V to 15 V in this charged state, the potential of the other electrode of the holding capacitor 22 (the pixel electrode 24) rises almost 15 V as well, thus changing from 15 V to approximately 30 V.

At this time, the potential of the common electrode 25 is held at 0 V, and thus the potential difference between the pixel electrodes 24 and the common electrode 25 is approximately 30 V, resulting in approximately twice the potential difference (15V) as that occurring during the potential input operations (a boosting operation).

According to the blackout operations described in this example, approximately double the voltage can be applied to electrophoretic element 26, and thus the image deletion operations can be executed in a short amount of time. These blackout operations can be applied instead of the processes S103 and S104 described earlier with reference to FIG. 6, and if a white image is then written in the processes S106 and S107 that follow thereafter, an image can be displayed in the same manner as described earlier in the embodiment. Employing the blackout operations described in this example also makes it possible to reduce the amount of time required for the overall image display operations, thereby making it possible to implement high-speed image display operations.

Although the second potential is inputted into the capacitance line C in the processes S203 and S303 in the aforementioned whiteout and blackout operations, it should be noted that a third potential, which is different from the second potential, maybe inputted in the processes S203 and S303. Any potential may be used as the third potential as long as it is a potential that enables the voltage applied to the electrophoretic element 26 through the execution of processes S203 and S303 to be boosted.

To be more specific, with the whiteout operations illustrated in FIG. 13A, the voltage applied to the electrophoretic element 26 can be boosted by reducing the potential of the capacitance line C, and therefore a potential that is at least lower than the first potential (15 V) may be used as the third potential, and the lower limit of the third potential may be set to a range whereby a voltage that exceeds the withstanding voltage is not applied to the select transistor 21.

On the other hand, with the blackout operations illustrated in FIG. 13B, a potential that is at least higher than the first potential (0 V) may be used as the third potential, and the upper limit thereof may be set to a range whereby a voltage that exceeds the withstanding voltage is not applied to the select transistor 21.

Note that inputting the second potential to the capacitance line C in processes S203 and S303 makes it possible to reduce the number of types of source potentials as compared to when using the third potential in addition to the first and second potentials, and thus is advantageous in that the power source can be simplified.

Although the aforementioned embodiment describes a configuration in which the common electrode driving circuit 5 is connected to the common electrode 25 and the capacitance line driving circuit 6 is connected to the capacitance line C, it should be noted that the pixel circuit illustrated in FIG. 9 may be employed.

With the pixel circuit illustrated in FIG. 9, one of the electrodes of the holding capacitor 22 is connected to the common electrode 25. Employing such a configuration consolidates the power source that controls the potential of the holding capacitor 22 and the power source that drives the common electrode 25 into a single source, thereby making it possible to simplify the configuration of the electrophoretic display apparatus. The form in which the electrode of the holding capacitor 22 and the common electrode 25 are connected can be made arbitrary; for example, the capacitance line C and the common electrode 25 may be connected within the display 2, or the common electrode driving circuit 5 and the capacitance line driving circuit 6 may be implemented as a single driving circuit outside of the display 2.

Electronic Device

Next, a case in which the electrophoretic display apparatus 1 according to the aforementioned embodiment is applied in an electronic device will be described.

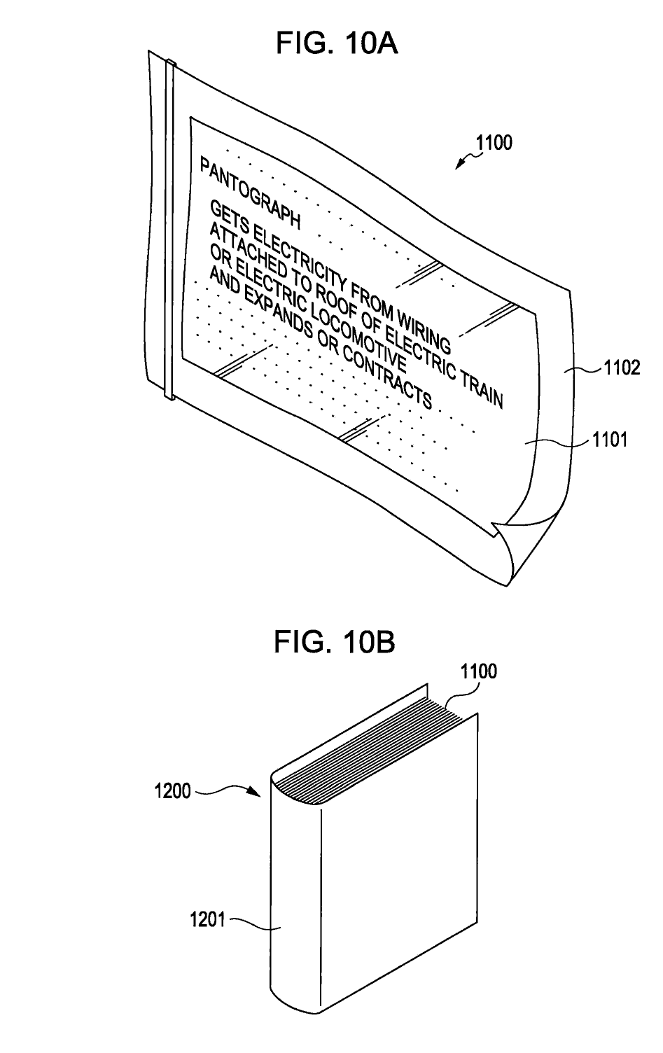

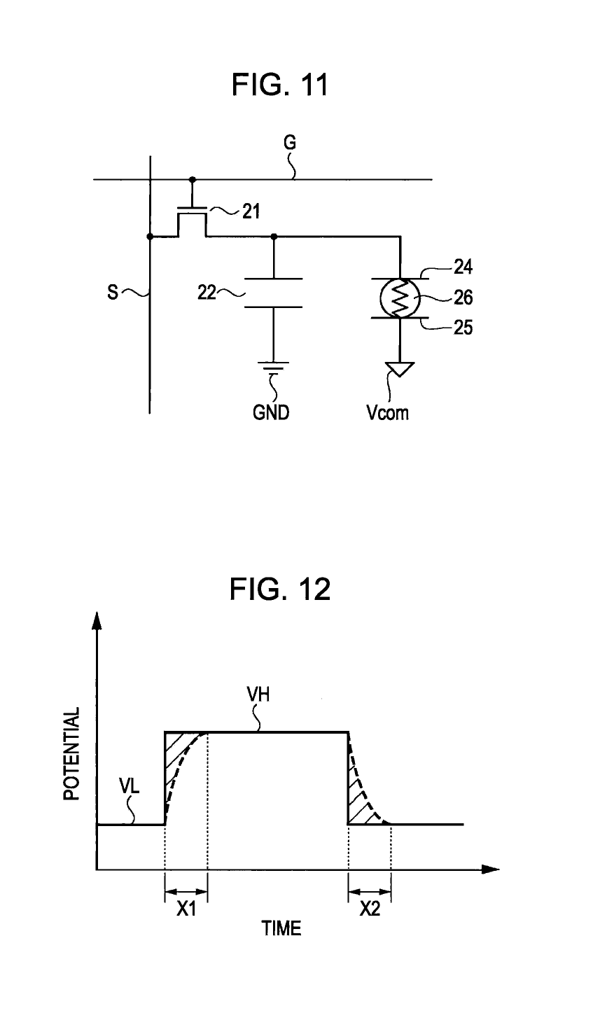

FIG. 10A is a perspective view illustrating the configuration of electronic paper 1100. The electronic paper 1100 includes the electrophoretic display apparatus 1 of the aforementioned embodiment in a display region 1101. The electronic paper 1100 is flexible, and is configured so as to include a main body portion 1102 composed of a rewritable sheet having the same texture and flexibility as normal paper.

FIG. 10B is a perspective view illustrating the configuration of an electronic notebook 1200. The electronic notebook 1200 has multiple sheets of the aforementioned electronic paper 1100 bound together within a cover 1201. The cover 1201 includes a display data input unit (not shown) through which image data sent from, for example, an external device is inputted. Accordingly, the display content can be changed or updated based on that image data while the electronic paper remains in a bound state.

The electronic paper 1100 and electronic notebook 1200 described thus far employ the electrophoretic display apparatus 1 according to this invention, and thus are electronic devices that include a display unit having superior display quality.

Note that the aforementioned electronic device is merely an example of an electronic device according to the invention, and is not intended to limit the technical scope of the invention. For example, the electrophoretic display apparatus according to the invention can be favorably used in the display units of other electronic devices, such as mobile telephones, mobile audio devices, and so on. Furthermore, the electrophoretic display apparatus installed in an electronic device may be configured so as to be rigid rather than flexible.

The entire disclosure of Japanese Patent Application Nos: 2009-068735, filed Mar. 19, 2009 and 2009-187967, filed Aug. 14, 2009 are expressly incorporated by reference herein.

What is claimed is:

1. An electro-optical apparatus comprising:
a display unit including a plurality of pixels;
a plurality of pixel electrodes, each of the plurality of pixel electrodes being provided for the pixel;
a common electrode facing the plurality of pixel electrodes;
an electro-optical layer disposed between the plurality of pixel electrodes and the common electrode;
a plurality of holding capacitors, each of the plurality of holding capacitors being provided for the pixel;
a capacitance line connected to the electrode of the holding capacitor; and
a control unit that controls the potentials of the plurality of pixel electrodes, the common electrode, and the capacitance line,
wherein the control unit executes, during an image display period in which an image is displayed in the display unit, a capacitance line potential change operation that changes the potential of the capacitance line in tandem with the potential of the common electrode so that the potential difference between the potential of the capacitance line and the potential of the common electrode decreases.

2. The electro-optical apparatus according to claim 1, wherein in the capacitance line potential change operation, the control unit changes the potential of the capacitance line in synchronization with the potential of the common electrode.

3. The electro-optical apparatus according to claim 1, wherein in the capacitance line potential change operation, the control unit sets the potentials of the common electrode and the capacitance line to the same potential.

4. The electro-optical apparatus according to claim 1, wherein prior to the capacitance line potential change operation, the control unit executes a discharge operation that discharges at least a part of the holding charge of the holding capacitor.

5. The electro-optical apparatus according to claim 4, wherein in the discharge operation, all of the plurality of pixel electrodes are set together to the same potential.

6. The electro-optical apparatus according to claim 1, wherein when changing the tone of some of the plurality of pixels in the display unit, the control unit executes the capacitance line potential changing operation.

7. The electro-optical apparatus according to claim 1, wherein the control unit executes the capacitance line potential changing operation when changing the tone of some of the plurality of pixels in the display unit, but holds the capacitance line at a constant potential when changing the tone of all of the plurality of pixels in the display unit.

8. The electro-optical apparatus according to claim 3, wherein the common electrode and the capacitance line are connected.

9. The electro-optical apparatus according to claim 1, wherein the common electrode and the capacitance line are insulated from each other.

10. The electro-optical apparatus according to claim 9, further comprising a capacitance line driving circuit connected to the capacitance line and a common electrode driving circuit connected to the common electrode,
wherein the capacitance line driving circuit includes a switch circuit that switches among multiple potentials to be supplied to the capacitance line, whereas the common electrode driving circuit includes a waveform generation circuit that generates a potential waveform to be inputted into the common electrode and a current amplification circuit connected to the waveform generation circuit.

11. The electro-optical apparatus according to claim 9, wherein during an image deletion operation for changing the display unit to a single tone, the control unit executes:
a potential input operation that inputs a first potential into the common electrode and the capacitance line and inputs a second potential that is different from the first potential into the plurality of pixel electrodes; and
a boosting operation that boosts the voltage applied to the electro-optical layer by inputting a third potential into the capacitance line.

12. The electro-optical apparatus according to claim 11, wherein the third potential is approximately equal to the second potential.

13. The electro-optical apparatus according to claim 1, wherein the electro-optical element is an electrophoretic element.

14. A driving method for an electro-optical apparatus, the electro-optical apparatus including:
a display unit including a plurality of pixels;
a plurality of pixel electrodes, each of the plurality of pixel electrodes being provided for the pixel;
a common electrode facing the plurality of pixel electrodes;
an electro-optical layer disposed between the plurality of pixel electrodes and the common electrode;
a plurality of holding capacitors, each of the plurality of holding capacitors being provided for the pixel; and
a capacitance line connected to the electrode of the holding capacitor;
the method comprising:
changing, during an image display period in which an image is displayed in the display unit, the potential of the capacitance line in tandem with the potential of the common electrode so that the potential difference between the potential of the capacitance line and the potential of the common electrode decreases.

15. The driving method for an electro-optical apparatus according to claim 14, further comprising:
discharging at least a part of the holding charge of the holding capacitor prior to the changing of the potential of the capacitance line.

16. The driving method for an electro-optical apparatus according to claim 15, wherein in the discharging, all of the plurality of pixel electrodes are set together to the same potential.

17. The driving method for an electro-optical apparatus according to claim 14, wherein the changing of the potential of the capacitance line is executed when changing the tone of some of the plurality of pixels in the display unit, but the capacitance line is held at a constant potential when changing the tone of all of the plurality of pixels in the display unit.

18. An electronic device comprising the electro-optical apparatus according to claim 1.
